(19) United States
(12) Patent Application Publication
(10) Pub. No.: US 2024/0127489 A1
(43) Pub. Date: Apr. 18, 2024

(54) EFFICIENT MAPPING COORDINATE CREATION AND TRANSMISSION

(71) Applicants: SONY GROUP CORPORATION, Tokyo (JP); Sony Corporation of America, New york, NY (US)

(72) Inventor: Danillo Graziosi, Flagstaff, AZ (US)

(21) Appl. No.: 18/114,910

(22) Filed: Feb. 27, 2023

Related U.S. Application Data
(60) Provisional application No. 63/378,547, filed on Oct. 6, 2022.

(51) Int. Cl. G06T 9/00; G06T 17/20

(52) U.S. Cl. CPC G06T 9/001; G06T 17/20

(57) ABSTRACT

A method is disclosed to generate (u,v) coordinates at the decoder side by using parameters of orthographic projection functions, transmitted via an atlas bitstream. With the parameters for orthographic projection, the decoder is able to efficiently generate (u,v) coordinates and avoid their expensive coding.

### CROSS-REFERENCE TO RELATED APPLICATION(S)

This application claims priority under 35 U.S.C. § 119(e) of the U.S. Provisional Patent Application Ser. No. 63/378,547, filed Oct. 6, 2022 and titled, “EFFICIENT MAPPING COORDINATE CREATION AND TRANSMISSION,” which is hereby incorporated by reference in its entirety for all purposes.

### FIELD OF THE INVENTION

The present invention relates to three dimensional graphics. More specifically, the present invention relates to mapping coordinates.

### BACKGROUND OF THE INVENTION

Recently, a novel method to compress volumetric content, such as point clouds, based on projection from 3D to 2D is being standardized. The method, also known as V3C (visual volumetric video-based compression), maps the 3D volumetric data into several 2D patches, and then further arranges the patches into an atlas image, which is subsequently encoded with a video encoder. The atlas images correspond to the geometry of the points, the respective texture, and an occupancy map that indicates which of the positions are to be considered for the point cloud reconstruction.

In 2017, MPEG had issued a call for proposal (CfP) for compression of point clouds. After evaluation of several proposals, currently MPEG is considering two different technologies for point cloud compression: 3D native coding technology (based on octree and similar coding methods), or 3D to 2D projection, followed by traditional video coding. In the case of dynamic 3D scenes, MPEG is using a test model software (TMC2) based on patch surface modeling, projection of patches from 3D to 2D image, and coding the 2D image with video encoders such as HEVC. This method has proven to be more efficient than native 3D coding, and is able to achieve competitive bitrates at acceptable quality.

Due to the success for coding 3D point clouds of the projection-based method (also known as the video-based method, or V-PCC), the standard is expected to include in future versions further 3D data, such as 3D meshes. However, current version of the standard is only suitable for the transmission of an unconnected set of points, so there is nomechanism to send the connectivity of points, as it is required in 3D mesh compression.

Methods have been proposed to extend the functionality of V-PCC to meshes as well. One possible way is to encode the vertices using V-PCC, and then the connectivity using a mesh compression approach, like TFAN or Edgebreaker. The limitation of this method is that the original mesh has to be dense, so that the point cloud generated from the vertices is not sparse and can be efficiently encoded after projection. Moreover, the order of the vertices affect the coding of connectivity, and different method to reorganize the mesh connectivity have been proposed. An alternative way to encode a sparse mesh is to use the RAW patch data to encode the vertices position in 3D. Since RAW patches encode (x,y,z) directly, in this method all the vertices are encoded as RAW data, while the connectivity is encoded by a similar mesh compression method, as mentioned before. Notice that in the RAW patch, the vertices may be sent in any preferred order, so the order generated from connectivity encoding can be used. The method can encode sparse point clouds, however, RAW patches are not efficient to encode 3D data, and further data such as the attributes of the triangle faces may be missing from this approach.

UVAtlas from Microsoft is the state-of-the-art automatic texture map generation, but requires a significant amount of time, and does optimization for a local frame only. V-PCC generates patches using orthographic projections, but targets point clouds only, so it does not address patch generation for meshes.

### SUMMARY OF THE INVENTION

A method is disclosed to generate (u,v) coordinates at the decoder side by using parameters of orthographic projection functions, transmitted via an atlas bitstream. With the parameters for orthographic projection, the decoder is able to efficiently generate (u,v) coordinates and avoid their expensive coding.

In one aspect, a method programmed in a non-transitory memory of a device comprises receiving patch identification information and mapping function parameters and generating (u,v) coordinates based on the patch identification and mapping function parameters. The method further comprises encoding a 3D mesh to generate the patch identification information and mapping function parameters. The mapping function parameters are encoded on an atlas sub-bitstream. The mapping function parameters comprise 3D to 2D mapping function parameters. Encoding the 3D mesh comprises: generating patches from dynamic mesh information and packing the patches on a texture atlas using orthographic projections. Generating (u,v) coordinates based on the patch identification and mapping function parameters comprises utilizing a function to generate the (u,v) coordinates from the patch identification and the mapping function parameters, wherein the mapping function parameters correspond with the patch identification. The (u,v) coordinates are generated based on transforms using a bounding box size, occupancy resolution, and scaling information. The method further comprises reconstructing a 3D mesh based on the (u,v) coordinates.

In another aspect, an apparatus comprises a non-transitory memory for storing an application, the application for: receiving patch identification information and mapping function parameters and generating (u,v) coordinates based on the patch identification and mapping function parameters and a processor coupled to the memory, the processor configured for processing the application. The application is configured for encoding a 3D mesh to generate the patch identification information and mapping function parameters. The mapping function parameters are encoded on an atlas sub-bitstream. The mapping function parameters comprise 3D to 2D mapping function parameters. Encoding the 3D mesh comprises: generating patches from dynamic mesh information and packing the patches on a texture atlas using orthographic projections. Generating (u,v) coordinates based on the patch identification and mapping function parameters comprises utilizing a function to generate the (u,v) coordinates from the patch identification and the mapping function parameters, wherein the mapping function parameters correspond with the patch identification. The (u,v) coordinates are generated based on transforms using a bounding box size, occupancy resolution, and scaling information. The application is configured for reconstructing a 3D mesh based on the (u,v) coordinates.

In another aspect, a system comprises an encoder configured for encoding a 3D mesh to generate the patch identification information and mapping function parameters and a decoder configured for: receiving patch identification information and mapping function parameters and generating (u,v) coordinates based on the patch identification and mapping function parameters. The mapping function parameters are encoded on an atlas sub-bitstream. The mapping function parameters comprise 3D to 2D mapping function parameters. Encoding the 3D mesh comprises: generating patches from dynamic mesh information and packing the patches on a texture atlas using orthographic projections. Generating (u,v) coordinates based on the patch identification and mapping function parameters comprises utilizing a function to generate the (u,v) coordinates from the patch identification and the mapping function parameters, wherein the mapping function parameters correspond with the patch identification. The (u,v) coordinates are generated based on transforms using a bounding box size, occupancy resolution, and scaling information. The decoder is configured for reconstructing the 3D mesh based on the (u,v) coordinates.

### BRIEF DESCRIPTION OF THE DRAWINGS

FIG. 1 illustrates a diagram of texture mapping according to some embodiments.

FIG. 2 illustrates a diagram of a decoding implementation according to some embodiments.

FIG. 3 illustrates a block diagram of an exemplary computing device configured to implement the efficient mapping coordinate generation and transmission method according to some embodiments.

### DETAILED DESCRIPTION OF THE PREFERRED EMBODIMENT

Meshes are composed of a set of polygons usually describing a surface of a volume. An efficient way to describe the surface properties of a mesh (for instance, its color characteristics) is to generate a texture atlas that maps the properties of the 3D surface onto a 2D surface. The result of the mapping function is stored in (u,v) coordinates and added to the mesh data, which is then further encoded with a mesh compression approach. However, the presence of (u,v) coordinates can significantly increase the size of the compressed meshes.

In the latest international point cloud compression standard, depth map images are being generated for point clouds using orthographic projections. The parameters of the projection are then encoded in a metadata bitstream known as the atlas bitstream, so the decoder only receives those parameters and applies the mapping function to each (u,v) coordinate of the depth map to then reconstruct the 3D information.

A method is disclosed to transmit the parameters for generating mapping coordinates for meshes using orthographic projections, similar to what is used in the V-PCC standard. With those parameters, the decoder is capable of generating the (u,v) coordinates and additionally reducing the size of the compressed meshes.

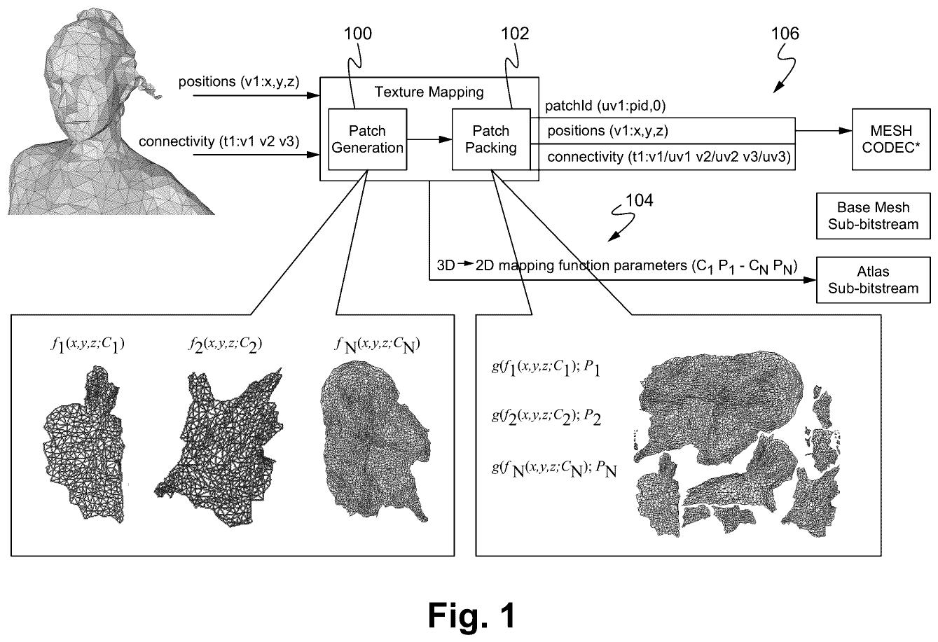

FIG. 1 illustrates a diagram of texture mapping according to some embodiments. In the step 100, patch generation is performed. Position information and connectivity information are received and used to generate patches. Patch generation involves f functions with position information (x, y, z) and an encoding parameter (C).

In the step 102, patch packing is implemented. Patch packing involves g functions which are based on the f function and the encoding parameter P. Mapping (f and g functions) is determined at the encoder side using orthographic projections. Patch generation and patch packing are described in U.S. Patent Application No. ***Attorney Docket No. Sony-76000***, titled ORTHOATLAS: TEXTURE MAP GENERATION FOR DYNAMIC MESHES USING ORTHOGRAPHIC PROJECTIONS, which is incorporated by reference in its entirety for all purposes.

In the step 104, 3D->2D mapping function parameters (C₁ and P₁ . . . C_{N} and P_{N}) are sent (e.g., to the decoder) in the Atlas sub-bitstream.

In the step 106, instead of sending u, v coordinates, a patchId is sent. For example, the patchID (pid) is sent to Draco, and Draco encodes and decodes the patch ID. The patchID (pid) indicates which parameters are used for the patch. For example, pid 1 corresponds with encoding parameters, C₁ and P₁, pid 2 corresponds with encoding parameters, C₂ and P₂, and so on. Using the appropriate parameters, the 2D projection is able to be recovered. The triangles in the 3D space are known, so the encoding parameters (e.g., C₁ and P₁) are able to be used to determine where on the 2D surface to find the texture coordinate.

In some embodiments, fewer or additional steps are implemented. In some embodiments, the order of the steps is modified.

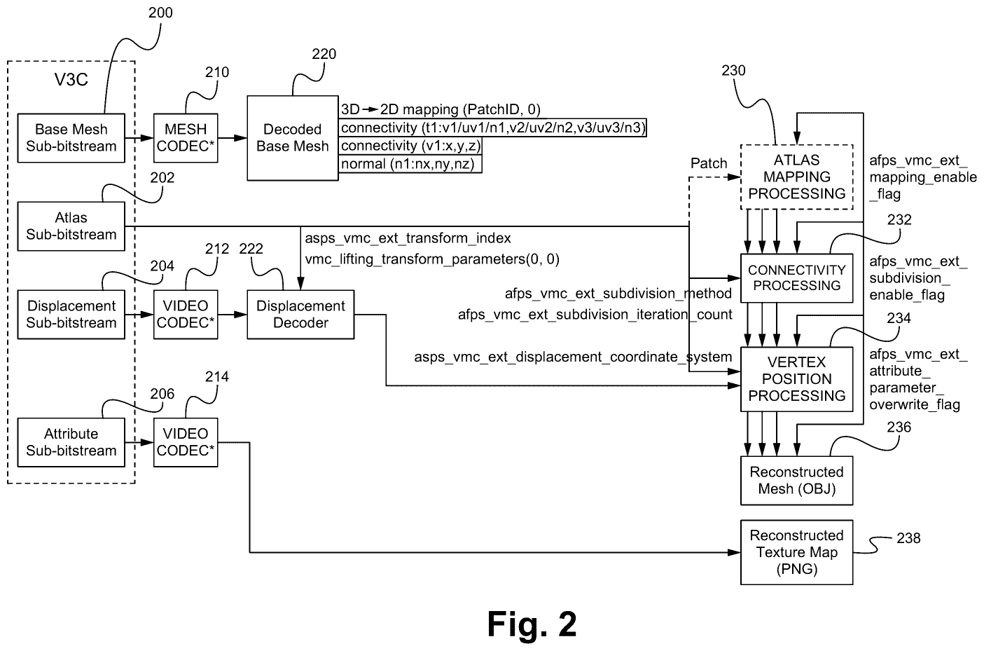

FIG. 2 illustrates a diagram of a decoding implementation according to some embodiments. V3C sub-bitstreams are received. For example, base mesh sub-bitstream 200, an atlas sub-bitstream 202, a displacement sub-bitstream 204 and an attribute sub-bitstream 206 are received. The sub-bitstreams are decoded by a mesh codec 210, a first video codec 212 or a second video codec 214. For example, the base mesh sub-bitstream 200 is decoded by the mesh coded 210; the displacement sub-bitstream 204 is decoded by the first video codec 212; and the attribute sub-bitstream 206 is decoded by the second video codec 214. The displacement sub-bitstream 204 is decoded by the video codec 212 and the displacement decoder 222.

The mesh codec 210 decodes the base mesh-sub-bitstream 200 and outputs a decoded base mesh 220, including the patch ID.

Atlas mapping processing 230 is an added implementation. The atlas mapping processing 230 receives (patchID, 0) information based on the decoded base mesh. The atlas mapping processing 230 also receives the parameters (e.g., C, P) from the atlas sub-bitstream 202 in the form of patches to re-generate the u, v coordinates.

The generated u, v coordinates are used in connectivity processing 232 and vertex processing 234. The object/mesh 236 is reconstructed based on the processing. Additionally, the texture map 238 is reconstructed based on the decoded attribute sub-bitstream 206.

The texture map coordinates are able to be derived by applying the following transforms:

$$[ \begin{matrix}{u}^{*} \\ {v}^{*}\end{matrix} ] = W + P * [ \begin{matrix}X - {BB}^{min} ( x ) \\ X - {BB}^{min} ( y ) \\ X - {BB}^{min} ( z )\end{matrix} ] \\ where : \\ P ( 0 ) = [ \begin{matrix}0 & 0 & - 1 \\ 0 & 1 & 0\end{matrix} ] , P ( 1 ) = [ \begin{matrix}0 & 0 & 1 \\ 1 & 0 & 0\end{matrix} ] , P ( 2 ) = [ \begin{matrix}1 & 0 & 0 \\ 0 & 1 & 0\end{matrix} ] , \\ P ( 3 ) = [ \begin{matrix}0 & 0 & 1 \\ 0 & 1 & 0\end{matrix} ] , P ( 4 ) = [ \begin{matrix}0 & 0 & - 1 \\ 1 & 0 & 0\end{matrix} ] , P ( 5 ) = [ \begin{matrix}- 1 & 0 & 0 \\ 0 & 1 & 0\end{matrix} ] \\ W ( 0 ) = [ \begin{matrix}{BB}^{max} - {BB}^{min} ( z ) \\ 0\end{matrix} ] , W ( 1 ) = [ \begin{matrix}0 \\ 0\end{matrix} ] , W ( 2 ) = [ \begin{matrix}0 \\ 0\end{matrix} ] , W ( 3 ) = [ \begin{matrix}0 \\ 0\end{matrix} ] , \\ W ( 4 ) [ \begin{matrix}{BB}^{max} - {BB}^{min} ( z ) \\ 0\end{matrix} ] , W ( 5 ) = [ \begin{matrix}{BB}^{max} - {BB}^{min} ( x ) \\ 0\end{matrix} ] ,$$

$$[ \begin{matrix}u \\ v\end{matrix} ] = [ \begin{matrix}1 / ( occ Res * width ) & 0 \\ 0 & 1 / ( occ Res * height )\end{matrix} ]$$

$$( [ \begin{matrix}{U}_{0} * occ Res \\ {V}_{0} * occ Res\end{matrix} ] + Q + R * [ \begin{matrix}LoD & 0 \\ 0 & LoD\end{matrix} ] [ \begin{matrix}{u}^{*} \\ {v}^{*}\end{matrix} ] )$$

$$where : \\ O ( 0 ° ) = [ \begin{matrix}0 \\ 0\end{matrix} ] , O ( 90 ° ) = [ \begin{matrix}heightOccCC * occ Res \\ 0\end{matrix} ] , \\ O ( 180 ° ) = [ \begin{matrix}widthOccCC * occ Res \\ heightOccCC * occ Res\end{matrix} ] , O ( 270 ° ) = [ \begin{matrix}0 \\ widthOccCC * occ Res\end{matrix} ] \\ R ( 0 ° ) = [ \begin{matrix}1 & 0 \\ 0 & 1\end{matrix} ] , R ( 90 ° ) = [ \begin{matrix}0 & - 1 \\ 1 & 0\end{matrix} ] , \\ R ( 180 ° ) = [ \begin{matrix}- 1 & 0 \\ 0 & - 1\end{matrix} ] , R ( 270 ° ) = [ \begin{matrix}0 & 1 \\ - 1 & 0\end{matrix} ] .$$

All of the operations are able to be combined into a single 4×4 homography transform matrix by using homogenous coordinates.

The transforms are used at the decoder to generate the u, v coordinates based on the bounding box size, the projection, occupancy resolution, scaling and/or other information/parameters.

Exemplary syntax includes:

```
Sequence Header
const uint8_t bitField =
  static_cast<int>(params.encodeDisplacementsVideo)
  |(static_cast<int>(params.encodeTextureVideo) << 1)
  |(static_cast<int>(params.bDeriveTextCoordFromPos << 2);
      .
      .
      .
if (params.bDeriveTextCoordFromPos) {
    uint32_t gutterBuf;
    memcpy(&gutterBuf, &params.gutter, sizeof(float));
    const uint16_t occupancyResolution = uint32_t(params.occupancyResolution);
    bitstream.write(gutterBuf);
    bitstream.write(occupancyResolution);
  }
Frame Header
const auto ccSizeMinusOne = uint16_t(connectedComponents.size( ) − 1);
bitstream.write(ccSizeMinusOne);
for (int i = 0; i < connectedComponents.size( );i++) {
    auto& cc = connectedComponents[i];
    bitstream.write(uint8_t(cc.getProjection( )));
    bitstream.write(uint8_t(cc.getOrientation( )));
    bitstream.write(uint16_t(cc.getU0( )));
    bitstream.write(uint16_t(cc.getV0( )));
    bitstream.write(uint16_t(cc.getSizeU( )));
    bitstream.write(uint16_t(cc.getSizeV( )));
    uint64_t scaleBuf;
    double scale = cc.getScale( );
    memcpy(&scaleBuf, &scale, sizeof(double));
    bitstream.write(scaleBuf);
  }
```

For example, in the syntax, in the sequence header, a flag is able to be sent to indicate that the texture coordinates are to be derived from the 3D position. Additionally, the size of the gutter and the occupancy resolution are able to be sent. In the frame header, the number of patches is sent. Additionally, for each patch, the projection, orientation, position and size in 2D space, and the scale are sent on the bitstream.

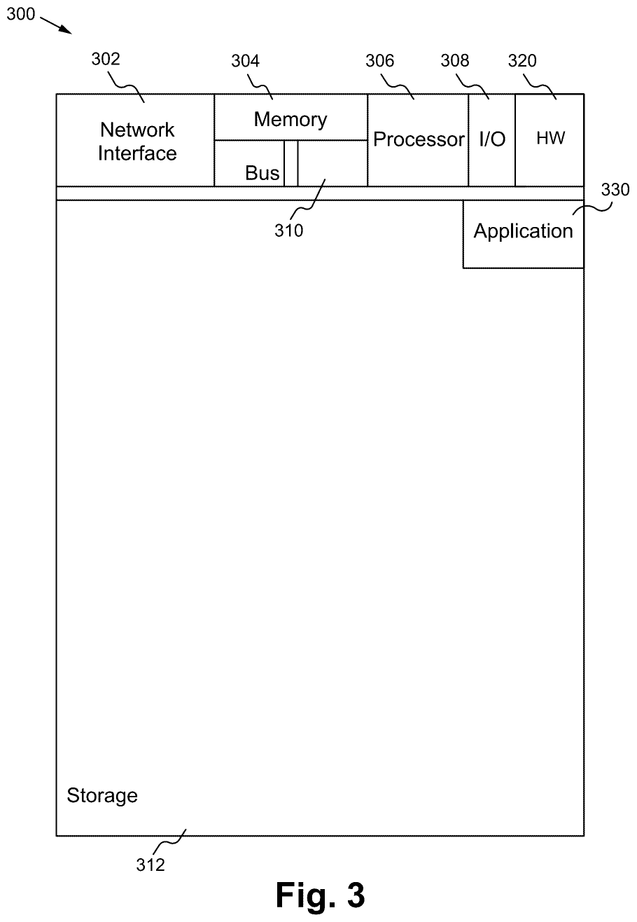

FIG. 3 illustrates a block diagram of an exemplary computing device configured to implement the efficient mapping coordinate generation and transmission method according to some embodiments. The computing device 300 is able to be used to acquire, store, compute, process, communicate and/or display information such as images and videos including 3D content. The computing device 300 is able to implement any of the encoding/decoding aspects. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, High Definition disc/drive, ultra-HD drive, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, screen, printer, modem, touchscreen, button interface and other devices. Efficient mapping coordinate generation and transmission application(s) 330 used to implement the efficient mapping coordinate generation and transmission implementation are likely to be stored in the storage device 312 and memory 304 and processed as applications are typically processed. More or fewer components shown in FIG. 3 are able to be included in the computing device 300. In some embodiments, efficient mapping coordinate generation and transmission hardware 320 is included. Although the computing device 300 in FIG. 3 includes applications 330 and hardware 320 for the efficient mapping coordinate generation and transmission implementation, the texture efficient mapping coordinate generation and transmission method is able to be implemented on a computing device in hardware, firmware, software or any combination thereof. For example, in some embodiments, the efficient mapping coordinate generation and transmission applications 330 are programmed in a memory and executed using a processor. In another example, in some embodiments, the efficient mapping coordinate generation and transmission hardware 320 is programmed hardware logic including gates specifically designed to implement the efficient mapping coordinate generation and transmission method.

In some embodiments, the efficient mapping coordinate generation and transmission application(s) 330 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the efficient mapping coordinate generation and transmission method, a device acquires or receives 3D content (e.g., point cloud content). The efficient mapping coordinate generation and transmission method is able to be implemented with user assistance or automatically without user involvement.

In operation, orthoAtlas (u,v) generation function parameters are sent to the decoder: texture map generation using orthographic projections and derived at decoder side. Elements are defined that together generate the mapping between a 3D vertex coordinate (x,y,z) to the 2D position in the atlas (u,v). The parameters for generating the mapping functions are efficiently encoded using an atlas bitstream. The result is a more efficient implementation where less data is transmitted.

As described, the transmission of (u,v) coordinates takes a significant amount of space in the compressed meshes representation. Nowadays, texture map generation relies on a complicated optimization to reduce mapping distortion and texture seams, the results of which (u,v coordinates) is encoded as part of the mesh representation. However, these coordinates take a significant amount of bits to be encoded, even with methods that efficiently use the corresponding (x,y,z) values and triangle structure. The efficient mapping coordinate generation and transmission method enables generating (u,v) coordinates at the decoder side by using parameters of orthographic projection functions, transmitted via an atlas bitstream. With the parameters for orthographic projection, the decoder is able to efficiently generate (u,v) coordinates and avoid their expensive encoding.

### Some Embodiments of Efficient Mapping Coordinate Creation and Transmission

1. A method programmed in a non-transitory memory of a device comprising:
receiving patch identification information and mapping function parameters; and
generating (u,v) coordinates based on the patch identification and mapping function parameters.
   2. The method of clause 1 further comprising encoding a 3D mesh to generate the patch identification information and mapping function parameters.
   3. The method of clause 2 wherein the mapping function parameters are encoded on an atlas sub-bitstream.
   4. The method of clause 2 wherein the mapping function parameters comprise 3D to 2D mapping function parameters.
   5. The method of clause 2 wherein encoding the 3D mesh comprises:
generating patches from dynamic mesh information; and
packing the patches on a texture atlas using orthographic projections.
   6. The method of clause 1 wherein generating (u,v) coordinates based on the patch identification and mapping function parameters comprises utilizing a function to generate the (u,v) coordinates from the patch identification and the mapping function parameters, wherein the mapping function parameters correspond with the patch identification.
   7. The method of clause 1 wherein the (u,v) coordinates are generated based on transforms using a bounding box size, occupancy resolution, and scaling information.
   8. The method of clause 1 further comprising reconstructing a 3D mesh based on the (u,v) coordinates.
   9. An apparatus comprising:
a non-transitory memory for storing an application, the application for:
   receiving patch identification information and mapping function parameters; and
   generating (u,v) coordinates based on the patch identification and mapping function parameters; and
a processor coupled to the memory, the processor configured for processing the application.
   10. The apparatus of clause 9 wherein the application is configured for encoding a 3D mesh to generate the patch identification information and mapping function parameters.
   11. The apparatus of clause 10 wherein the mapping function parameters are encoded on an atlas sub-bitstream.
   12. The apparatus of clause 10 wherein the mapping function parameters comprise 3D to 2D mapping function parameters.
   13. The apparatus of clause 10 wherein encoding the 3D mesh comprises:
generating patches from dynamic mesh information; and
packing the patches on a texture atlas using orthographic projections.
   14. The apparatus of clause 9 wherein generating (u,v) coordinates based on the patch identification and mapping function parameters comprises utilizing a function to generate the (u,v) coordinates from the patch identification and the mapping function parameters, wherein the mapping function parameters correspond with the patch identification.
   15. The apparatus of clause 9 wherein the (u,v) coordinates are generated based on transforms using a bounding box size, occupancy resolution, and scaling information.
   16. The apparatus of clause 9 wherein the application is configured for reconstructing a 3D mesh based on the (u,v) coordinates.
   17. A system comprising:
an encoder configured for encoding a 3D mesh to generate the patch identification information and mapping function parameters; and
a decoder configured for:
   receiving patch identification information and mapping function parameters; and
   generating (u,v) coordinates based on the patch identification and mapping function parameters.
      18. The system of clause 17 wherein the mapping function parameters are encoded on an atlas sub-bitstream.
      19. The system of clause 17 wherein the mapping function parameters comprise 3D to 2D mapping function parameters.
      20. The system of clause 17 wherein encoding the 3D mesh comprises:
generating patches from dynamic mesh information; and
packing the patches on a texture atlas using orthographic projections.
   21. The system of clause 17 wherein generating (u,v) coordinates based on the patch identification and mapping function parameters comprises utilizing a function to generate the (u,v) coordinates from the patch identification and the mapping function parameters, wherein the mapping function parameters correspond with the patch identification.
   22. The system of clause 17 wherein the (u,v) coordinates are generated based on transforms using a bounding box size, occupancy resolution, and scaling information.
   23. The system of clause 17 wherein the decoder is configured for reconstructing the 3D mesh based on the (u,v) coordinates.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
receiving patch identification information and mapping function parameters; and
generating (u,v) coordinates based on the patch identification and mapping function parameters.

2. The method of claim 1 further comprising encoding a 3D mesh to generate the patch identification information and mapping function parameters.

3. The method of claim 2 wherein the mapping function parameters are encoded on an atlas sub-bitstream.

4. The method of claim 2 wherein the mapping function parameters comprise 3D to 2D mapping function parameters.

5. The method of claim 2 wherein encoding the 3D mesh comprises:
generating patches from dynamic mesh information; and
packing the patches on a texture atlas using orthographic projections.

6. The method of claim 1 wherein generating (u,v) coordinates based on the patch identification and mapping function parameters comprises utilizing a function to generate the (u,v) coordinates from the patch identification and the mapping function parameters, wherein the mapping function parameters correspond with the patch identification.

7. The method of claim 1 wherein the (u,v) coordinates are generated based on transforms using a bounding box size, occupancy resolution, and scaling information.

8. The method of claim 1 further comprising reconstructing a 3D mesh based on the (u,v) coordinates.

9. An apparatus comprising:
a non-transitory memory for storing an application, the application for:
receiving patch identification information and mapping function parameters; and
generating (u,v) coordinates based on the patch identification and mapping function parameters; and
a processor coupled to the memory, the processor configured for processing the application.

10. The apparatus of claim 9 wherein the application is configured for encoding a 3D mesh to generate the patch identification information and mapping function parameters.

11. The apparatus of claim 10 wherein the mapping function parameters are encoded on an atlas sub-bitstream.

12. The apparatus of claim 10 wherein the mapping function parameters comprise 3D to 2D mapping function parameters.

13. The apparatus of claim 10 wherein encoding the 3D mesh comprises:
generating patches from dynamic mesh information; and
packing the patches on a texture atlas using orthographic projections.

14. The apparatus of claim 9 wherein generating (u,v) coordinates based on the patch identification and mapping function parameters comprises utilizing a function to generate the (u,v) coordinates from the patch identification and the mapping function parameters, wherein the mapping function parameters correspond with the patch identification.

15. The apparatus of claim 9 wherein the (u,v) coordinates are generated based on transforms using a bounding box size, occupancy resolution, and scaling information.

16. The apparatus of claim 9 wherein the application is configured for reconstructing a 3D mesh based on the (u,v) coordinates.

17. A system comprising:
an encoder configured for encoding a 3D mesh to generate patch identification information and mapping function parameters; and
a decoder configured for:
receiving the patch identification information and the mapping function parameters; and
generating (u,v) coordinates based on the patch identification and mapping function parameters.

18. The system of claim 17 wherein the mapping function parameters are encoded on an atlas sub-bitstream.

19. The system of claim 17 wherein the mapping function parameters comprise 3D to 2D mapping function parameters.

20. The system of claim 17 wherein encoding the 3D mesh comprises:
generating patches from dynamic mesh information; and
packing the patches on a texture atlas using orthographic projections.

21. The system of claim 17 wherein generating (u,v) coordinates based on the patch identification and mapping function parameters comprises utilizing a function to generate the (u,v) coordinates from the patch identification and the mapping function parameters, wherein the mapping function parameters correspond with the patch identification.

22. The system of claim 17 wherein the (u,v) coordinates are generated based on transforms using a bounding box size, occupancy resolution, and scaling information.

23. The system of claim 17 wherein the decoder is configured for reconstructing the 3D mesh based on the (u,v) coordinates.
